(19) United States
(12) Patent Application Publication
(10) Pub. No.: US 2007/0204611 A1
(43) Pub. Date: Sep. 6, 2007

(54) Exhaust heat recovery apparatus

(75) Inventors: Daisaku Sawada, Gotenba-shi (JP); Shinichi Mitani, Susono-shi (JP); Hiroshi Yaguchi, Susono-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Toyota Jidosha Kabushiki Kaisha

(21) Appl. No.: 11/712,441

(22) Filed: Mar. 1, 2007

(30) Foreign Application Priority Data
Mar. 1, 2006 (JP) 2006-055438

(51) Int. Cl. F02G 1/04; F01B 29/10

(52) U.S. Cl. 60/520

(57) ABSTRACT

Provided is an exhaust heat recovery apparatus that includes: an exhaust heat recovery unit that recovers thermal energy from exhaust gas discharged from a heat engine; and a power transmission-switching device that cuts off the connection between an output shaft of the heat engine and an output shaft of the exhaust heat recovery unit when the heat engine is started. With the exhaust heat recovery apparatus, the reduction in the power output from the heat engine, from which exhaust heat is recovered, is suppressed when the exhaust heat of the heat engine is recovered.

### INCORPORATION BY REFERENCE

The disclosure of Japanese Patent Application No. 2006-055438 filed on Mar. 1, 2006 including the specification, drawings and abstract is incorporated herein by reference in its entirety.

### BACKGROUND OF THE INVENTION

1. Field of the Invention

The present invention relates to an exhaust heat recovery apparatus that recovers the exhaust heat from a heat engine.

2. Description of the Related Art

An exhaust heat recovery apparatus is available that, using a heat engine, recovers the exhaust heat from an internal combustion engine that is mounted on a vehicle, such as a passenger car, a bus and a truck. As an example of the exhaust heat recovery apparatus used for such a purpose, there is the Stirling engine, which is excellent in theoretical thermal efficiency. Japanese Patent Application Publication No. 2003-518458 (JP-A-2003-518458) discloses a technology in which a clutch is provided between the internal combustion engine and the Stirling engine, and the Stirling engine that is started earlier is used to start the internal combustion engine.

The Stirling engine described in JP-A-2003-518458 uses a burner or the like as the heat source of the Stirling engine, and is not used as the exhaust heat recovery apparatus that uses the exhaust gas from an internal combustion engine as the heat source. In addition, the motive power from the Stirling engine described in JP-A-2003-518458 is used to drive an air conditioning system, etc., and is not output together with the motive power from the internal combustion engine.

For this reason, if the technology described in JP-A-2003-518458 is applied to the exhaust heat recovery from heat engines (internal combustion engines, for example), and only the exhaust gas is used as the heat source, there is a possibility that the thermal energy required to allow the exhaust heat recovery unit (the Stirling engine, for example) to operate in a self-sustaining manner cannot be obtained. If the motive power from the exhaust heat recovery unit is output together with the motive power from the heat engine, unless the exhaust heat recovery unit can operate in a self-sustaining manner, not only it is impossible to obtain motive power from the exhaust heat recovery unit, but also the exhaust heat recovery unit can be a load to the heat engine, from which exhaust heat is recovered, which may result in the reduction in the power output from the internal combustion engine.

### SUMMARY OF THE INVENTION

In consideration of the above circumstances, the present invention provides an exhaust heat recovery apparatus that, when exhaust heat is recovered from a heat engine, suppresses the reduction in the power output from a heat engine, from which exhaust heat is recovered.

According to an aspect of the present invention, provided is an exhaust heat recovery apparatus that includes: an exhaust heat recovery unit that recovers thermal energy from exhaust gas discharged from a heat engine; and a power transmission-switching device that cuts off the connection between an output shaft of the heat engine and an output shaft of the exhaust heat recovery unit when the heat engine is started.

According to the exhaust heat recovery apparatus as described above, when the heat engine, from which exhaust heat is recovered, is started, the power transmission-switching device cuts off the connection between the output shaft of the heat engine and the output shaft of the exhaust heat recovery unit. Thus, the motive power produced by the heat engine at the time of the starting thereof is not used by the exhaust heat recovery unit, so that it is possible to suppress the reduction in the power output from the heat engine when the heat engine is started.

It is also preferable that, in the exhaust heat recovery apparatus, the power transmission-switching device connect the output shaft of the heat engine and the output shaft of the exhaust heat recovery unit when it becomes possible for the exhaust heat recovery unit to operate in a self-sustaining manner.

According to such an exhaust heat recovery apparatus, when the exhaust heat recovery unit is started, the power transmission-switching device is engaged to start the exhaust heat recovery unit using the motive power from the heat engine when it becomes possible for the exhaust heat recovery unit to operate in a self-sustaining manner. Thus, the exhaust heat recovery unit can operate in a self-sustaining manner immediately after the starting thereof, so that the exhaust heat recovery unit will not be a load to the heat engine. Consequently, it becomes possible to suppress the reduction in the power output from the heat engine when the exhaust heat is recovered from the heat engine.

### BRIEF DESCRIPTION OF THE DRAWINGS

The features, advantages thereof, and technical and industrial significance of this invention will be better understood by reading the following detailed description of preferred embodiments of the invention, when considered in connection with the accompanying drawings, in which:

FIG. 1 is a sectional view showing a Stirling engine, which functions as an exhaust heat recovery means of an exhaust heat recovery apparatus according to an embodiment;

FIG. 2 is a sectional view showing an example of the construction of an air bearing that the Stirling engine includes, which functions as the exhaust heat recovery means of the exhaust heat recovery apparatus according to the embodiment;

FIG. 3 is an explanatory diagram showing an example of an approximately linear motion linkage, which is used to support a piston;

FIG. 4 is an overall view showing a configuration of the exhaust heat recovery apparatus according to the embodiment;

FIG. 5 is an explanatory diagram showing a configuration of a start controller for controlling the starting of the exhaust heat recovery apparatus according to the embodiment;

FIG. 6 is a flow chart showing a procedure of the starting control of the exhaust heat recovery apparatus according to the embodiment;

FIGS. 7 to 10 are exemplary diagrams for explaining a method of determining an index that is used to determine whether the Stirling engine can operate in a self-sustaining manner, in the starting control of the exhaust heat recovery apparatus according to the embodiment;

FIG. 11 is a flow chart showing a procedure of the starting control according to a modified example of the exhaust heat recovery apparatus according to the embodiment; and

FIG. 12 is a diagram for explaining the starting control according to the modified example of the exhaust heat recovery apparatus according to the embodiment.

### DETAILED DESCRIPTION OF THE PREFERRED EMBODIMENTS

In the following description and the accompanying drawings, the present invention will be described in more detail with reference to exemplary embodiments. It should be noted that the present invention is not limited to the preferred embodiments (hereinafter referred to merely as “the embodiment(s)”) for carrying out the invention. The components of the embodiments include ones that those skilled in the art would easily think of, and ones that are substantially the same as the former ones. The description given below illustrates a case where a Stirling engine is used as an exhaust heat recovery means to recover thermal energy from the exhaust gas discharged from an internal combustion engine, which functions as a heat engine. In addition to the Stirling engine, another exhaust heat recovery device, such as one using the Brayton cycle, may be used as the exhaust heat recovery means. The type of heat engine is arbitrary.

This embodiment includes: an exhaust heat recovery unit that recover thermal energy from the exhaust gas discharged from the heat engine; and a power transmission-switching device provided between an output shaft of the heat engine and an output shaft of the exhaust heat recovery unit, wherein, when the heat engine, from which exhaust heat is recovered, is started, the power transmission-switching device cuts off the connection between the output shaft of the heat engine and the output shaft of the exhaust heat recovery unit until the time to start the exhaust heat recovery unit. The exhaust heat recovery unit of the embodiment will be described first.

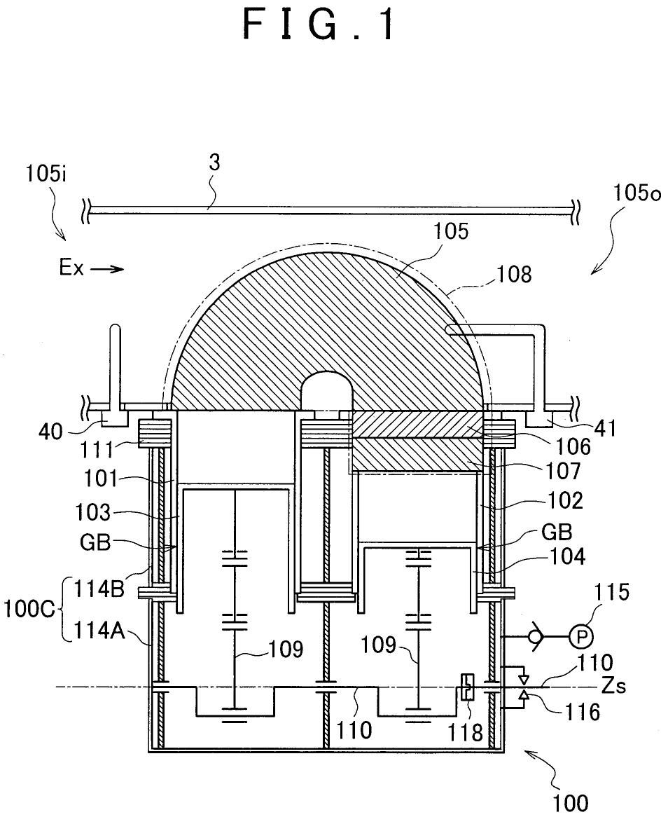

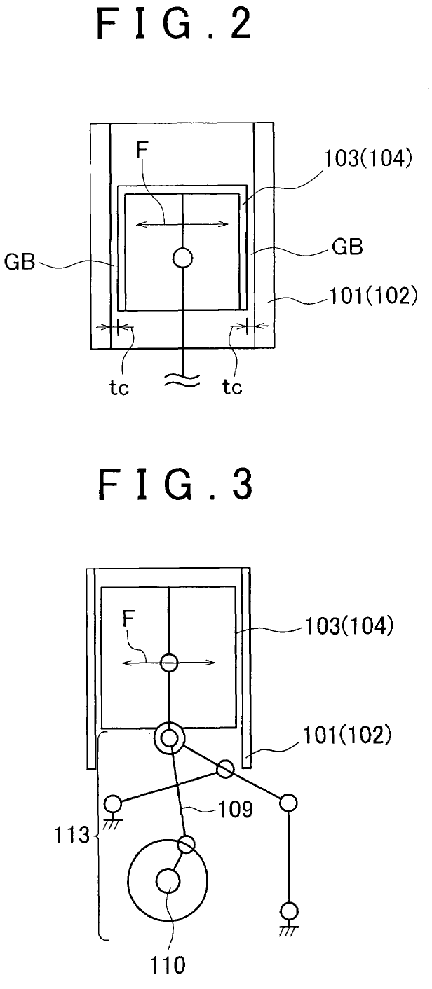

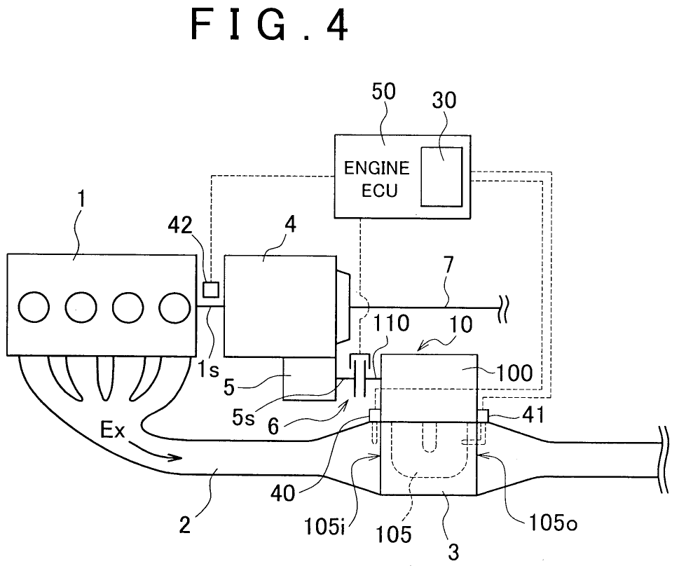

FIG. 1 is a sectional view showing the Stirling engine, which functions as the exhaust heat recovery unit of this embodiment. FIG. 2 is a sectional view showing an example of the construction of an air bearing that the Stirling engine includes, which functions as the exhaust heat recovery unit of the embodiment. FIG. 3 is an explanatory diagram showing an example of an approximately linear motion linkage, which is used to support a piston. The Stirling engine 100, which functions as the exhaust heat recovery unit of the embodiment, is a so-called α-type in-line two-cylinder Stirling engine. In the Stirling engine 100, arranged in an in-line arrangement are: a high temperature-side piston 103, which is a first piston, housed in a high temperature-side cylinder 101, which is a first cylinder; and a low temperature-side piston 104, which is a second piston, housed in a low temperature-side cylinder 102, which is a second cylinder.

The high temperature-side cylinder 101 and the low temperature-side cylinder 102 are directly or indirectly supported by, or fixed to a base plate 111, which functions as a reference body. In the Stirling engine 100 of the embodiment, the base plate 111 serves as a positional reference of the components of the Stirling engine 100. With this configuration, it is made possible to ensure the accuracy of the relative position between the components. In addition, as described later, in the Stirling engine 100 of the embodiment, respective gas bearings GB are interposed between the high temperature-side cylinder 101 and the high temperature-side piston 103, and between the low temperature-side cylinder 102 and the low temperature-side piston 104.

By fixing the high temperature-side cylinder 101 and the low temperature-side cylinder 102 directly or indirectly to the base plate 111, which functions as the reference body, it is possible to maintain the clearance between the piston and the cylinder with precision. Thus, the function of the gas bearings GB is satisfactorily carried out. In addition, it becomes easy to assemble the Stirling engine 100.

A heat exchanger 108 constituted of a substantially U-shaped heater 105, a regenerator 106, and a cooler 107 is disposed between the high temperature-side cylinder 101 and the low temperature-side cylinder 102. If the heater 105 is formed in a substantially U-shape in this way, it is possible to easily dispose the heater 105 even in a relatively narrow space, such as in the exhaust gas passage of the internal combustion engine. In addition, if the high temperature-side cylinder 101 and the low temperature-side cylinder 102 are arranged in an in-line arrangement as in the case of the Stirling engine 100, it is possible to relatively easily dispose the heater 105 even in a cylindrical space, such as in the exhaust gas passage of the internal combustion engine.

One end of the heater 105 is positioned next to the high temperature-side cylinder 101, and the other end thereof is positioned next to the regenerator 106. One end of the regenerator 106 is positioned next to the heater 105, and the other end thereof is positioned next to the cooler 107. One end of the cooler 107 is positioned next to the regenerator 106, and the other end thereof is positioned next to the low temperature-side cylinder 102.

A working fluid (air in the embodiment) is confined in the high temperature-side cylinder 101, the low temperature-side cylinder 102 and the heat exchanger 108, and realizes the Stirling cycle with the heat supplied from the heater 105 and the heat discharged from the cooler 107 to drive the Stirling engine 100. The heater 105 and the cooler 107 may be formed by bundling a plurality of tubes made of a material that has high thermal conductivity and excellent thermal resistance, for example. The regenerator 106 may be made of a porous heat storage unit. The composition of the heater 105, the cooler 107 and the regenerator 106 is not limited to this example. Specifically, the composition may be suitably selected depending on the thermal conditions of the subject from which exhaust heat is recovered, the specifications of the Stirling engine 100, etc.

The high temperature-side piston 103 and the low temperature-side piston 104 are supported in the high temperature-side cylinder 101 and the low temperature-side cylinder 102, respectively, with the respective gas bearings GB interposed therebetween. In other words, the piston is supported in the cylinder without any piston rings. In this way, it is possible to reduce the friction between the piston and the cylinder, thereby improving the thermal efficiency of the Stirling engine 100. In addition, the reduction in the friction between the piston and the cylinder makes it possible to recover thermal energy by operating the Stirling engine 100 even under the operating conditions of a low-temperature heat source and low temperature difference, such as in the case of the exhaust heat recovery of the internal combustion engine.

In order to form the gas bearing GB, as shown in FIG. 2, the clearance tc between the high temperature-side piston 103 and the high temperature-side cylinder 101 is set to a few tens of microns all around the high temperature-side piston 103. The low temperature-side piston 104 and the low temperature-side cylinder 102 have a similar configuration. The high temperature-side cylinder 101, the high temperature-side piston 103, the low temperature-side cylinder 102 and the low temperature-side piston 104 may be made of an easily worked, metallic material, for example.

The reciprocation of the high temperature-side piston 103 and the low temperature-side piston 104 is transmitted to a crankshaft 110, which functions as an output shaft, through a connecting rod 109, and converted into rotational motion. The connecting rod 109 may be supported by an approximately linear motion linkage (a Grasshopper linkage, for example) 113 shown in FIG. 3. Such a linkage allows the high temperature-side piston 103 and the low temperature-side piston 104 to reciprocate substantially linearly. If the connecting rod 109 is supported by the approximately linear motion linkage 113 in this way, the side force F (the force in the radial direction of the piston) exerted on the high temperature-side piston 103 becomes substantially zero, so that it is possible to satisfactorily support the piston using a gas bearing GB that has a small load capacity.

As shown in FIG. 1, the components of the Stirling engine 100, such as the high temperature-side cylinder 101, the high temperature-side piston 103, the connecting rod 109 and the crankshaft 110, are housed in a housing 100C. The housing 100C of the Stirling engine 100 includes a crankcase 114A and a cylinder block 114B. A pressurizing means 115 increases the pressure in the exhaust heat recovery unit-side housing 100C. The purpose of this is to pressurize the working fluid in the high temperature-side cylinder 101, the low temperature-side cylinder 102 and the heat exchanger 108 to obtain more power output from the Stirling engine 100.

In the Stirling engine 100 of the embodiment, a sealed bearing 116 is fitted to the housing 100C, and supports the crankshaft 110. The power output from the crankshaft 110 is output from the housing 100C through a flexible coupling 118. An Oldham's coupling is used as the flexible coupling 118 in the embodiment. Next, the configuration of the exhaust heat recovery apparatus according to the embodiment will be described.

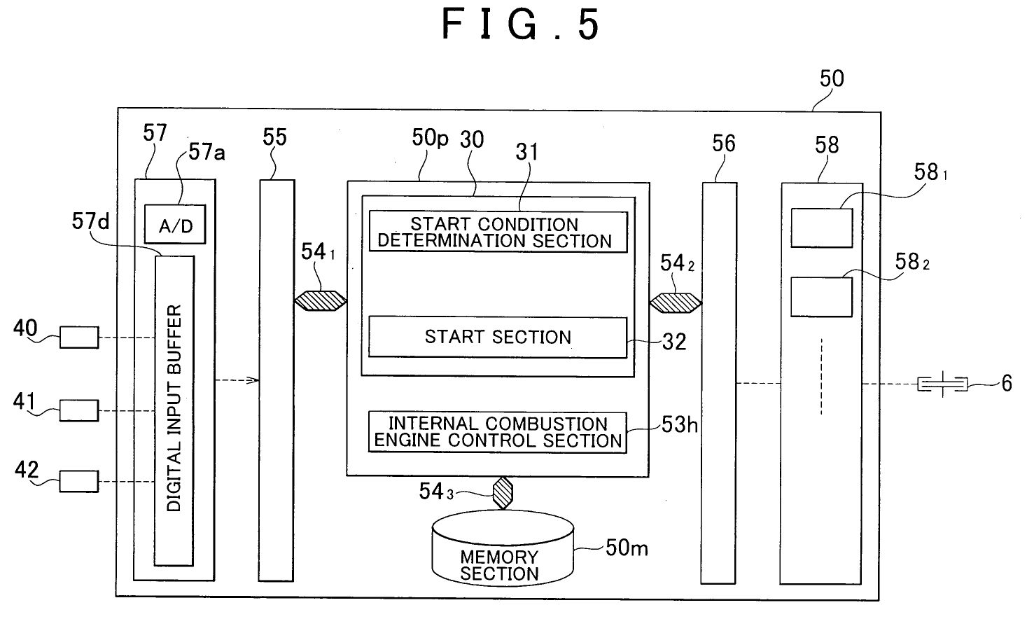

FIG. 4 is an overall view showing a configuration of the exhaust heat recovery apparatus according to the embodiment. The exhaust heat recovery apparatus 10 according to the embodiment includes the exhaust heat recovery unit, and the power transmission-switching device. The power transmission-switching device is provided between the output shaft of the heat engine and the output shaft of the exhaust heat recovery unit, and connects and disconnects between the heat engine and the exhaust heat recovery unit. In the embodiment, the above-described Stirling engine 100 is used as the exhaust heat recovery unit, and a reciprocating internal combustion engine 1 is used as the heat engine. A clutch 6 is used as the power transmission-switching device.

The heater 105 that the Stirling engine 100 includes is disposed in an exhaust gas passage 2 of the internal combustion engine 1. The regenerator (see FIG. 1) 106 of the Stirling engine 100 may also be disposed in the exhaust gas passage 2. The heater 105 that the Stirling engine 100 includes is provided in a hollow heater case 3, which is provided on the exhaust gas passage 2. An exhaust gas temperature sensor 40 for measuring the temperature of the exhaust gas Ex flowing onto the heater 105 is provided on the inlet (heater case inlet) 105i side of the heater case 3. A heater temperature sensor 41 for measuring the temperature of the heater 105 is provided on the outlet (heater case outlet) 105o side of the heater 105.

In the embodiment, the thermal energy of the exhaust gas Ex recovered using the Stirling engine 100 is converted into kinetic energy by the Stirling engine 100. The crankshaft 110, which functions as the output shaft of the Stirling engine 100, is fitted with the clutch 6, which functions as the power transmission-switching device. The motive power from the Stirling engine 100 is transmitted to a transmission 5 for the exhaust heat recovery unit through the clutch 6. An output shaft is of the internal combustion engine 1 is connected to a transmission 4 for the internal combustion engine. The internal combustion engine transmission 4 combines the motive power from the internal combustion engine 1 and the motive power from the Stirling engine 100, which is output from the exhaust heat recovery apparatus transmission 5, and outputs the resultant motive power to an output shaft 7. The engine rotation speed of the internal combustion engine 1 is measured by an internal combustion engine rotation speed sensor 42, which is provided near the output shaft 1s of the internal combustion engine 1.

The clutch 6 is provided between the output shaft 1s of the internal combustion engine 1 and the crankshaft 110, which functions as the output shaft of the Stirling engine 100 with the internal combustion engine transmission 4 and the exhaust heat recovery apparatus transmission 5 interposed between the clutch 6 and the output shaft is. The clutch 6 cuts and establishes the mechanical connection between the output shaft is of the internal combustion engine 1 and the crankshaft 110 of the Stirling engine 100 as needed. The clutch 6 is controlled by a start controller 30 of the exhaust heat recovery apparatus according to the embodiment. As described later, in the embodiment, the start controller 30 is provided in an engine ECU (Electronic Control Unit) 50.

The exhaust heat recovery apparatus transmission 5 is constructed so as to be able to change the gear ratio, or the speed ratio between the output shaft and an input shaft 5s. Although it is difficult to rapidly change the rotation speed of the Stirling engine 100, it is possible to combine the motive power from the Stirling engine 100 and the motive power from the internal combustion engine 1 over a wide range of the engine rotation speed of the internal combustion engine 1. Next, the start controller 30 of the exhaust heat recovery apparatus, which is used to control the exhaust heat recovery apparatus 10 according to the embodiment, will be described.

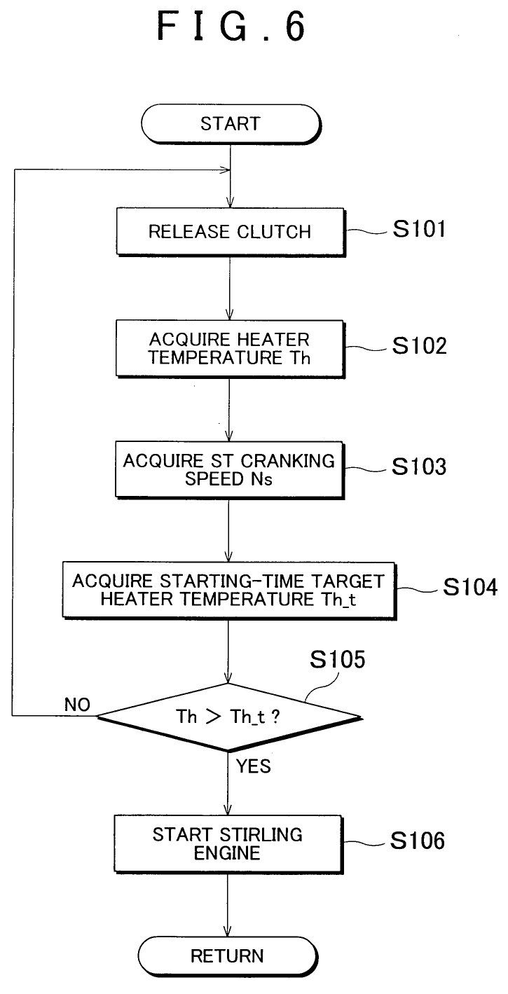

FIG. 5 is an explanatory diagram showing a configuration of the start controller for controlling the starting of the exhaust heat recovery apparatus according to the embodiment. As shown in FIG. 5, the start controller 30 of the embodiment is incorporated into the engine ECU 50. The engine ECU 50 includes a CPU (Central Processing Unit) 50p, a memory section 50m, input and output ports 55 and 56, and input and output interfaces 57 and 58.

Alternatively, the start controller 30 of the embodiment may be prepared separately from the engine ECU 50, and may be connected to the engine ECU 50. For the purpose of realizing the starting control according to the embodiment, the exhaust heat recovery apparatus may be configured so that the start controller 30 can use the function of controlling the Stirling engine 100 etc. that the engine ECU 50 has.

The start controller 30 includes a section 31 for determining whether the condition for starting has been satisfied, and a start section 32. These sections perform the starting control according to the embodiment. In the embodiment, the start controller 30 is incorporated into the CPU 50p that constitutes the engine ECU 50. In addition, the CPU 50p is provided with an internal combustion engine control section 53h, and controls the operation of the internal combustion engine 1 using this section.

The CPU 50p and the memory section 50m are connected to each other and to the input and output ports 55 and 56 through buses 54₁ to 54₃. Thus, the starting condition determination section 31 and the start section 32, which constitute the start controller 30, can exchange control data with each other, and one of these sections can send commands to the other section. In addition, the start controller 30 can acquire operation control data of the internal combustion engine 1, the Stirling engine 100, etc. from the engine ECU 50, and use the data. Moreover, the start controller 30 allows the starting control according to the embodiment to interrupt the operation control routine with which the engine ECU 50 is previously provided.

The input interface 57 is connected to the input port 55. Connected to the input interface 57 are the exhaust gas temperature sensor 40, the heater temperature sensor 41, the internal combustion engine rotation speed sensor 42, etc., which are the sensors to obtain information necessary to control the starting of the exhaust heat recovery apparatus. The signals output from these sensors are sent to the input port 55 after being converted into the signals that the CPU 50p can use through an A/D converter 57a and a digital input buffer 57d in the input interface 57. Thus, the CPU 50p can acquire the information necessary to control the operation and the starting of the internal combustion engine 1.

The output interface 58 is connected to the output port 56. Controlled objects (the clutch 6 in the embodiment) necessary to perform the starting control are connected to the output interface 58. The output interface 58 is provided with the control circuit 58₁, 58₂, etc., and operates the controlled objects according to the control signals that are calculated in the CPU 50p. With this configuration, the CPU 50p of the engine ECU 50 can control the Stirling engine 100 and the internal combustion engine 1 according to the output signals from the sensors.

Stored in the memory section 50m are control maps and computer programs including the procedure of the starting control according to the embodiment, or control data, control maps, etc. that are used to perform the starting control according to the embodiment. The memory section 50m may be a volatile memory, such as a RAM (Random Access Memory), a nonvolatile memory, such as a flush memory, or a combination thereof.

The above computer programs may realize the procedure of the starting control according to the embodiment in combination with the computer programs already stored in the CPU 50p. The start controller 30 may realize the functions of the starting condition determination section 31 and the start section 32 using a dedicated hardware instead of the computer programs. Next, the starting control according to the embodiment will be described. Please refer to FIGS. 1 to 5 if necessary in reading the following description. The above-described start controller 30 realizes the starting control according to the embodiment.

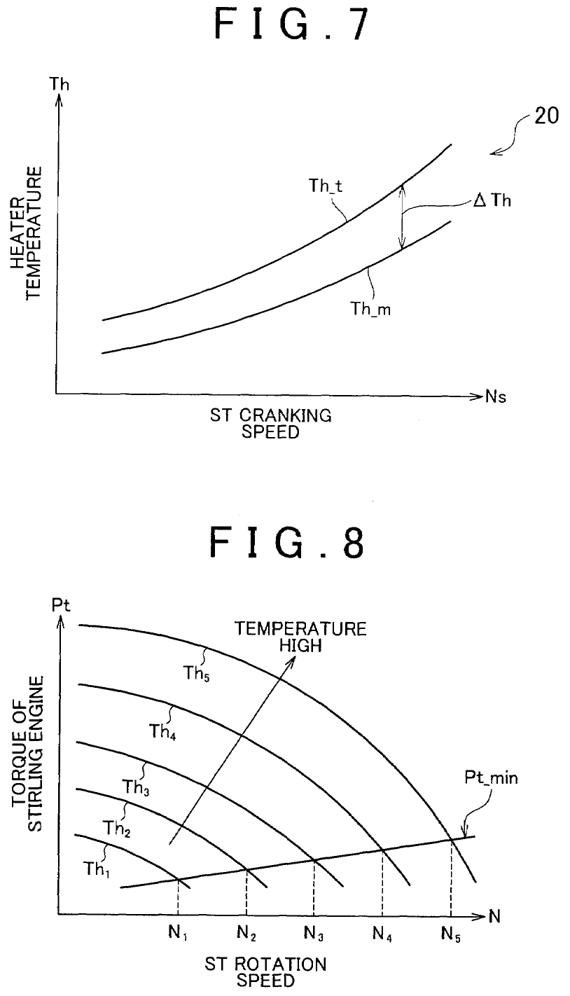

FIG. 6 is a flow chart showing a procedure of the starting control according to the embodiment. Once the starting control according to the embodiment is started, the starting condition determination section 31 that the start controller 30 includes releases the clutch 6 (S101) to cut off the mechanical connection between the Stirling engine 100 and the internal combustion engine 1. Thus, even if the Stirling engine 100 cannot operate in a self-sustaining manner, the motive power from the internal combustion engine 1 is not used to drive the Stirling engine 100. Accordingly, it is possible to suppress the reduction in the power output from the internal combustion engine 1.

It should be noted that, when the internal combustion engine 1 is started, the clutch 6 is released, and the mechanical connection between the Stirling engine 100 and the internal combustion engine 1 is cut off. In other words, the output shaft 1s of the internal combustion engine 1 and the crankshaft 110 of the Stirling engine 100 is separated. Consequently, the Stirling engine 100 does not use the motive power produced by the internal combustion engine 1 at the time of the starting thereof. In this way, it is possible to suppress the reduction in the power output from the internal combustion engine 1, the increase in the fuel consumption, and the worsening of the exhaust emission.

The starting condition determination section 31 acquires, from the heater temperature sensor 41, the temperature Th of the heater 105 (hereinafter referred to as “the heater temperature”) that the Stirling engine 100 includes (S102). The heater temperature Th is the representative temperature of the heater 105 that the Stirling engine 100 includes, and it is assumed that every part of the heater 105 is at the heater temperature Th. The acquired temperature Th is the temperature before the Stirling engine 100 is started.

The starting condition determination section 31 acquires the Stirling engine cranking speed (hereinafter referred to as “the ST cranking speed”) Ns (S103). In the embodiment, the Stirling engine 100 and the internal combustion engine 1 are connected to each other through the clutch 6, and the motive power from the Stirling engine 100 is combined with the motive power from the internal combustion engine 1 through the exhaust heat recovery apparatus transmission 5. Thus, if the clutch 6 is engaged to start the Stirling engine 100, the Stirling engine 100 rotates at speeds having a fixed ratio to the engine rotation speeds of the internal combustion engine 1. Accordingly, the ST cranking speed Ns is equal to the rotation speed of the input shaft 5s of the exhaust heat recovery apparatus transmission 5 at the time of engaging the clutch 6 when the Stirling engine 100 is started.

The ST cranking speed Ns is calculated using the engine rotation speed Ne of the internal combustion engine 1 that is acquired by the internal combustion engine rotation speed sensor 42, and the gear ratios, or the speed ratios of the internal combustion engine transmission 4 and the exhaust heat recovery apparatus transmission 5. After acquiring the heater temperature Th and the ST cranking speed Ns, the starting condition determination section 31 acquires the target heater temperature Th_t at the time of the starting (S104). The starting-time target heater temperature Th_t will now be described.

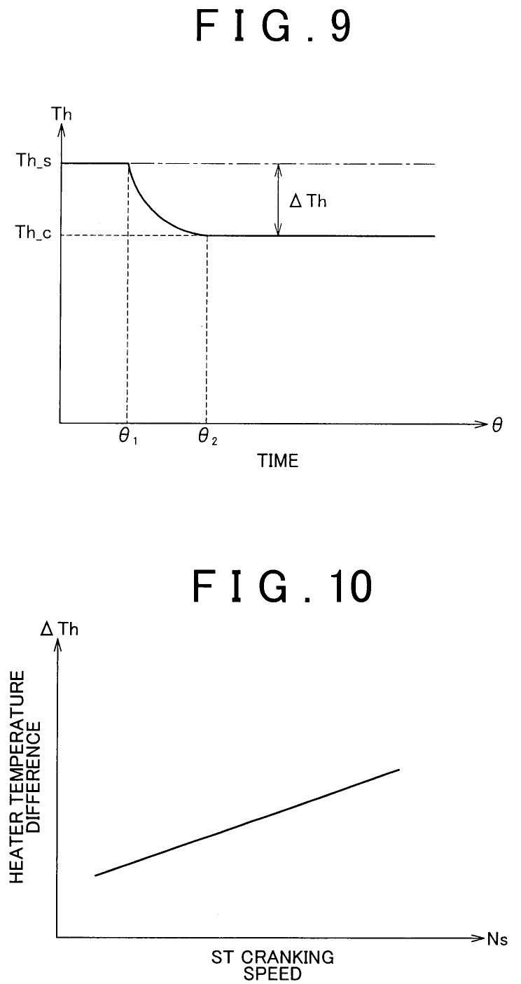

FIGS. 7 to 10 are explanatory diagrams for explaining a method of determining an index that is used to determine whether the Stirling engine can operate in a self-sustaining manner in the starting control according to the embodiment. FIG. 7 shows a control map 20 in which an index that is used to determine whether the Stirling engine can operate in a self-sustaining manner is.

The starting-time target heater temperature Th_t (see FIG. 7) is an index that is used to determine whether the Stirling engine 100 can operate in a self-sustaining manner. If the heater temperature Th acquired in step S102 is higher than the starting-time target heater temperature Th_t, it is determined that the Stirling engine 100 can operate in a self-sustaining manner. As shown in FIG. 7, the starting-time target heater temperature Th_t is a function of the ST cranking speed Ns, and increases as the ST cranking speed Ns increases.

As shown in FIG. 7, the starting-time target heater temperature Th_t is the value obtained by adding the heater temperature difference ΔTh to the target heater temperature Th_m when the Stirling engine is in operation. Specifically, the starting-time target heater temperature is defined as Th_t=Th_m+ΔTh. The in-operation target heater temperature Th_m is the heater temperature at which the Stirling engine 100 can operate in a self-sustaining manner at the ST cranking speed Ns. “The Stirling engine 100 can operate in a self-sustaining manner” means that the Stirling engine carries out a minimum operational function. “The Stirling engine carries out a minimum operational function” means that the Stirling engine 100 overcomes the friction and the inertial mass of the drive train, and produces motive power.

FIG. 8 shows the relation between the torque produced by the Stirling engine 100 and the rotation speed of the Stirling engine 100 (Stirling engine rotation speed, which is hereinafter referred to as “the ST rotation speed”). The solid lines Th1, Th2 and so on in FIG. 8 are isothermal torque curves that show the variation of the torque of the Stirling engine 100 at the respective heater temperatures. As seen from the isothermal torque curves of FIG. 8, the torque Pt of the Stirling engine 100 decreases as the ST rotation speed N increases if the temperature is the same. It should be noted that Th1<Th2<Th3<Th4<Th5. If the ST rotation speed N is the same, the higher the heater temperature Th is, the greater the torque Pt produced by the Stirling engine 100 is.

The line indicated with Pt_min in FIG. 8 shows the variation of the torque Pt_min (minimum necessary torque) necessary for the Stirling engine 100 to carry out the minimum operational function. Specifically, under the conditions in which the torque Pt produced by the Stirling engine 100 is smaller than the Pt_min, the Stirling engine 100 cannot overcome the friction and the inertial mass of the drive train and produce the motive power, that is, cannot operate in a self-sustaining manner. For this reason, the Stirling engine 100 has to be started under the conditions in which the torque Pt is greater than the minimum necessary torque Pt_min. The minimum necessary torque Pt_min increases as the ST rotation speed N increases.

The heater temperature of the isothermal torque curve that intersects with the line of the minimum necessary torque Pt_min is the in-operation target heater temperature Th_m of the Stirling engine 100. The heater temperature Th at which the minimum necessary torque Pt_min can be produced is uniquely determined corresponding to a particular ST rotation speed N. Specifically, for an ST rotation speed N, the heater temperature of the isothermal torque curve that intersects with the minimum necessary torque Pt_min is the in-operation target heater temperature Th_m corresponding to the ST rotation speed N. Accordingly, once the ST rotation speed N is determined, the in-operation target heater temperature Th_m is also uniquely determined.

For example, in the example shown in FIG. 8, the in-operation target heater temperature Th_m when the ST rotation speed is N₁ is Th₁, and the in-operation target heater temperature Th_m when the ST rotation speed is N₃ is Th₃. In this way, the in-operation target heater temperature Th_m of the Stirling engine 100 is determined. The relationship between the ST cranking speed Ns and the in-operation target heater temperature Th_m shown in FIG. 7 is similar to the relationship between the above-described ST rotation speed N and the in-operation target heater temperature Th_m. Thus, it is possible to obtain the in-operation target heater temperature Th_m shown in FIG. 7 using the relationship between the above-described ST rotation speed N and the in-operation target heater temperature Th_m.

As seen from FIG. 7, the in-operation target heater temperature Th_m increases as the ST cranking speed Ns increases. If the heater temperature is lower than the in-operation target heater temperature Th_m, the Stirling engine 100 cannot carry out the minimum operational function, and therefore cannot operate in a self-sustaining manner. As a result, the Stirling engine 100 is driven by the internal combustion engine 1. Specifically, in this case, the Stirling engine 100 applies a load to the internal combustion engine 1. Thus, when exhaust heat is recovered by operating the Stirling engine 100, it is necessary to always operate the Stirling engine 100 at a higher temperature than the in-operation target heater temperature Th_m.

FIG. 9 shows the variation of the heater temperature Th with time from before to after starting the Stirling engine 100. Once the Stirling engine 100 is started, the Stirling engine 100 recovers the thermal energy from the exhaust gas Ex discharged from the internal combustion engine 1 through the heater 105, and converts the energy into kinetic energy. For this reason, if the temperature of the heater 105 is compared between before and after starting the Stirling engine 100, the temperature thereof after starting the Stirling engine 100 is lower than that before the starting. The thermal energy corresponding to the temperature difference ΔTh (see FIG. 9) of the heater 105 (heater temperature difference) between before and after starting the Stirling engine 100 is converted into kinetic energy.

In this way, after starting the Stirling engine 100, the heater temperature Th decreases. Accordingly, even if the heater temperature Th is higher than the in-operation target heater temperature Th_m when the Stirling engine 100 is started, the heater temperature Th can be lower than the in-operation target heater temperature Th_m, after starting the Stirling engine 100. Accordingly, in the embodiment, the starting-time target heater temperature Th_t is determined so as to keep the heater temperature Th after starting the Stirling engine 100 equal to or higher than the in-operation target heater temperature Th_m, in consideration of the heater temperature difference ΔTh. In the embodiment, the starting-time target heater temperature Th_t is the sum of the in-operation target heater temperature Th_m and the heater temperature difference ΔTh (Th_t=Th_m+ΔTh). The heater temperature difference ΔTh is determined in the following way.

Th_s shown in FIG. 9 is the temperature (stopped-state heater temperature) that the heater has while, although the heater 105 is being supplied with the exhaust gas Ex, the Stirling engine 100 is stopped. The exhaust gas Ex supplied to the heater 105 under such conditions is the exhaust gas Ex discharged from the internal combustion engine 1 while the internal combustion engine 1 is in steady operation at a rotation speed corresponding to the ST cranking speed Ns. Th_c is the temperature (steady-operation-state heater temperature) that the heater has when the Stirling engine 100 is in steady operation at the ST cranking speed Ns.

In the example shown in FIG. 9, the Stirling engine 100 is started at θ₁, and the Stirling engine 100 reaches a steady state operation at θ₂. The thermal energy corresponding to the difference between the stopped-state heater temperature Th_s of the Stirling engine 100 and the steady-operation-state heater temperature Th_c thereof is converted into kinetic energy of the Stirling engine 100.

In this embodiment, the heater temperature difference ΔTh is defined as ΔTh=Th_s−Th_c. As shown in FIG. 10, the heater temperature difference ΔTh is a function of the rotation speed (ST cranking rotation speed) Ns at the time of starting the Stirling engine 100, and increases as the ST cranking speed Ns increases.

The starting-time target heater temperature Th_t is Th_m+ΔTh. As described above, the in-operation target heater temperature Th_m and the heater temperature difference ΔTh are determined depending on the ST cranking speed Ns acquired in step S103. The starting condition determination section 31 provides the acquired ST cranking speed Ns to the control map 20 shown in FIG. 7, and obtains the starting-time target heater temperature Th_t from the control map 20.

The starting condition determination section 31 then compares the heater temperature Th acquired in step S102 and the starting-time target heater temperature Th_t acquired in step S104 (S105). If Th≦Th_t (No in step S105), it is determined that the Stirling engine 100 cannot operate in a self-sustaining manner. If the Stirling engine 100 is started in this case, the temperature of the heater 105 can be lower than the in-operation target heater temperature Th_m, which can result in the reduction in the power output from the internal combustion engine 1 and/or the increase in the fuel consumption. Accordingly, in this case, the starting condition determination section 31 repeats steps S101 to S105 until Th>Th_t is satisfied.

If Th>Th_t (Yes in step S105), it is determined that the Stirling engine 100 can operate in a self-sustaining manner. In this case, the start section 32 starts the Stirling engine 100 (S106). Specifically, the start section 32 brings the clutch 6 into engagement, and starts the Stirling engine 100 using the internal combustion engine 1. Once the Stirling engine 100 is started, the Stirling engine 100 starts operating in a self-sustaining manner, recovering the thermal energy from the exhaust gas Ex from the internal combustion engine 1. The motive power produced by the Stirling engine 100 and the motive power produced by the internal combustion engine 1 are combined through the exhaust heat recovery apparatus transmission 5, and output from the output shaft 7.

It is preferable that, if the temperature of the heater 105 is lower than the in-operation target heater temperature Th_m, the start controller 30 release the clutch 6 because the Stirling engine 100 cannot operate in a self-sustaining manner. With this setting, the Stirling engine 100 will not be a load to the internal combustion engine 1, and it is therefore possible to suppress the reduction in the power output from the internal combustion engine 1 and the increase in the fuel consumption.

In the starting control of the exhaust heat recovery apparatus according to this embodiment, the power output (torque) from the Stirling engine 100 at the time of starting the Stirling engine 100 is estimated from the temperature of the heater 105, and, if the output power satisfies the condition for allowing the Stirling engine 100 to operate in a self-sustaining manner, the Stirling engine is started. Thus, once the Stirling engine 100 is started, the Stirling engine 100 immediately starts operating in a self-sustaining manner, so that the Stirling engine 100 will not be a load to the internal combustion engine 1. Consequently, it is possible to suppress the reduction in the power output from the internal combustion engine 1 and the increase in the fuel consumption due to the starting of the Stirling engine 100. Next, the starting control according to a modified example of the embodiment will be described.

A feature of the starting control according to the modified example of the above embodiment is that, when the time integral of the difference between the temperature of the exhaust gas that flows onto the heater and the predetermined, starting-time target heater temperature exceeds a predetermined, target value, it is determined that the Stirling engine 100, which functions as the exhaust heat recovery means, can operate in a self sustaining manner. In the other points, the starting control according to the modified example is similar to that of the above embodiment.

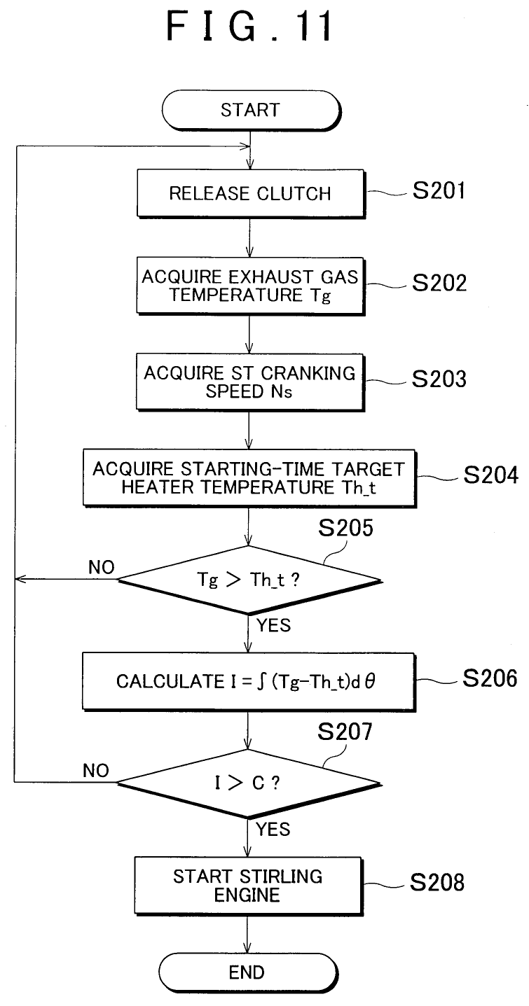

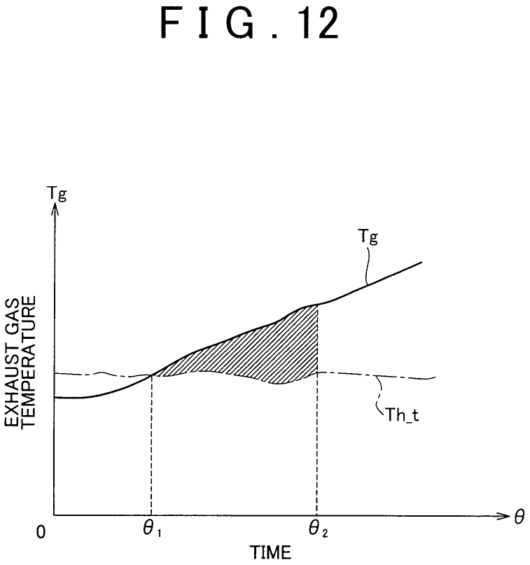

FIG. 11 is a flow chart showing a procedure of the starting control according to the modified example of the embodiment. FIG. 12 is a diagram for explaining the starting control according to the modified example of the embodiment. Once the starting control according to the modified example is started, the starting condition determination section 31 that the start controller 30 includes releases the clutch 6 (S201) to cut off the mechanical connection between the Stirling engine 100 and the internal combustion engine 1

The starting condition determination section 31 then acquires the temperature Tg of the exhaust gas (hereinafter referred to as “the exhaust gas temperature”) flowing onto the heater 105 that the Stirling engine 100 includes, from the exhaust gas temperature sensor 40 (see FIGS. 1 and 5) that is provided at the inlet 105i of the heater case 3 (S202). The starting condition determination section 31 acquires the ST cranking speed Ns (S203), and acquires the starting-time target heater temperature Th_t (S204). The starting-time target heater temperature Th_t is as described above.

The starting condition determination section 31 compares the exhaust gas temperature Tg and the starting-time target heater temperature Th_t (S205). If Tg≦Th_t (No in step S205; up to θ1 in FIG. 12), the starting condition determination section 31 repeats the above-described steps S201 to S205 until Tg>Th_t is satisfied.

If Tg>Th_t (Yes in step S205), the starting condition determination section 31 calculates the time integral (temperature difference integral) 1 of the difference between the exhaust gas temperature Tg and the starting-time target heater temperature Th_t (S206). The temperature difference integral I is ∫(Tg−Th_t)dθ, and the integral from when Tg>Th_t is satisfied (θ1 in FIG. 12) is calculated. For example, the temperature difference integral I from θ1 to θ2 corresponds to the hatched area between the solid line showing the variation of the exhaust gas temperature Tg and the chain line showing the variation of the starting-time target heater temperature Th_t. The temperature difference integral I can be used as an index of the total amount of the heat that the heater 105 has received since Tg>Th_t is satisfied.

In the modified example, whether the heater temperature Th has exceeded the starting-time target heater temperature Th_t is determined based on the total amount of the heat that the heater 105 of the Stirling engine 100 has received. If the heater 105 is exposed to the exhaust gas Ex that has a higher temperature than the starting-time target heater temperature Th_t for a predetermined period of time, the heater temperature Th exceeds the starting-time target heater temperature Th_t. For this determination, the starting condition determination section 31 compares the temperature difference integral I calculated in step S206 and a predetermined target value for determination (hereinafter referred to as “the target heat reception amount”) C that is determined through experiments and analyses (S207).

If I≦C (No in step S207), it is determined that the heater temperature Th of the Stirling engine 100 has not exceeded the starting-time target heater temperature Th_t. In this case, it is determined that the Stirling engine 100 cannot operate in a self sustaining manner, and the starting condition determination section 31 therefore repeats steps S201 to S207 until I>C is satisfied. If I>C (Yes in step S207), it is determined that the heater temperature Th of the Stirling engine 100 has exceeded the starting-time target heater temperature Th_t. In this case, it is determined that the Stirling engine 100 can operate in a self-sustaining manner, and the start section 32 therefore starts the Stirling engine 100 (S208).

In the modified example, by sensing the temperature of the exhaust gas Ex flowing onto the heater 105, it is possible to determine whether the Stirling engine 100 can operate in a self-sustaining manner without using the heater temperature sensor 41. In general, the internal combustion engine 1 has the exhaust gas temperature measuring means, and therefore, it is possible to measure the temperature of the exhaust gas Ex flowing onto the heater 105 using the exhaust gas temperature measuring means. Accordingly, in the modified example, by using the conventional, exhaust gas temperature measuring means, it is possible to omit the heater temperature sensor 41, so that it is possible to simplify the structure.

As described above, in the embodiment and the modified example thereof, the clutch, which functions as the power transmission-switching device, is provided between the output shaft of the internal combustion engine, which functions as the heat engine from which exhaust heat is recovered, and the output shaft of the Stirling engine, which functions as the exhaust heat recovery means. At the time of starting the Stirling engine, the clutch is engaged when it becomes possible for the Stirling engine to operate in a self-sustaining manner, and the Stirling engine is started using the motive power from the internal combustion engine. In this way, the Stirling engine can operate in a self-sustaining manner immediately after the starting, and the Stirling engine will therefore not be a load to the internal combustion engine. As a result, it is possible to suppress the reduction in the power output from the internal combustion engine when exhaust heat is recovered from the internal combustion engine.

In addition, because the Stirling engine will not be a load to the internal combustion engine, it is possible to suppress the increase in the fuel consumption of the internal combustion engine. Moreover, because the Stirling engine is started when it becomes possible for the Stirling engine to operate in a self-sustaining manner, it is possible to reduce the possibility that the temperature of the exhaust gas after passing through the Stirling engine becomes lower than a set value. Thus, if the configuration is adopted in which the exhaust gas after passing through the Stirling engine is purified through a purifying catalyst, it is possible to suppress the decrease in the purification performance. In addition, because whether the Stirling engine can operate in a self-sustaining manner is determined based on the temperature of the heater, it becomes easy to determine whether the self-sustaining operation is possible, which improves controllability.

As described above, the exhaust heat recovery apparatuses according to the present invention are useful to recover exhaust heat from heat engines, and in particular, suitable for suppressing the reduction in the power output from the heat engine, from which exhaust heat is recovered.

While the invention has been described with reference to exemplary embodiments thereof, it is to be understood that the invention is not limited to the exemplary embodiments or constructions. To the contrary, the invention is intended to cover various modifications and equivalent arrangements. In addition, while the various elements of the exemplary embodiments are shown in various combinations and configurations, which are exemplary, other combinations and configurations, including more, less or only a single element, are also within the spirit and scope of the invention.

What is claimed is:

1. An exhaust heat recovery apparatus, comprising:
an exhaust heat recovery unit that recovers thermal energy from exhaust gas discharged from a heat engine; and
a power transmission-switching device that cuts off the connection between an output shaft of the heat engine and an output shaft of the exhaust heat recovery unit when the heat engine is started.

2. The exhaust heat recovery apparatus according to claim 1, wherein
the power transmission-switching device connects the output shaft of the heat engine and the output shaft of the exhaust heat recovery unit when it becomes possible for the exhaust heat recovery unit to operate in a self-sustaining manner.

3. The exhaust heat recovery apparatus according to claim 2, wherein,
when a temperature of a heater that the exhaust heat recovery unit includes exceeds a predetermined, starting-time target heater temperature, the power transmission-switching device determines that the exhaust heat recovery unit can operate in a self-sustaining manner.

4. The exhaust heat recovery apparatus according to claim 3, wherein
the starting-time target heater temperature is determined so as to keep the temperature of the heater after the exhaust heat recovery unit is started equal to or higher than a heater temperature that is required for the exhaust heat recovery unit to operate in a self-sustaining manner at a cranking speed at which the exhaust heat recovery unit is started.

5. The exhaust heat recovery apparatus according to claim 4, wherein
the starting-time target heater temperature has a value obtained by adding a difference between a temperature that the heater has while, although the heater is being supplied with the exhaust gas, the exhaust heat recovery unit is stopped, and a temperature that the heater has when the exhaust heat recovery unit is in steady operation at the cranking speed, to the heater temperature that is required for the exhaust heat recovery unit to operate in a self-sustaining manner.

6. The exhaust heat recovery apparatus according to claim 2, wherein,
when a time integral of a difference between a predetermined, starting-time target heater temperature and a temperature of the exhaust gas flowing onto a heater, from when the temperature of the exhaust gas flowing onto the heater exceeds the starting-time target heater temperature, exceeds a predetermined target value for determination, the power transmission-switching device determines that the exhaust heat recovery unit can operate in a self-sustaining manner.

7. The exhaust heat recovery apparatus according to claim 6, wherein
the starting-time target heater temperature is determined so as to keep the temperature of the heater after the exhaust heat recovery unit is started equal to or higher than a heater temperature that is required for the exhaust heat recovery unit to operate in a self-sustaining manner at a cranking speed at which the exhaust heat recovery unit is started.

8. The exhaust heat recovery apparatus according to claim 7, wherein
the starting-time target heater temperature has a value obtained by adding a difference between a temperature that the heater has while, although the heater is being supplied with the exhaust gas, the exhaust heat recovery unit is stopped, and a temperature that the heater has when the exhaust heat recovery unit is in steady operation at the cranking speed, to the heater temperature that is required for the exhaust heat recovery unit to operate in a self-sustaining manner.
